(19) United States
(12) Patent Application Publication
(10) Pub. No.: US 2026/0120985 A1
(43) Pub. Date: Apr. 30, 2026

(54) A CIRCUIT BREAKER

(71) Applicant: Hitachi Energy Ltd, Zürich (CH)

(72) Inventors: Brian Christopher, Smithfield, PA (US); Matthew D. Cuppett, Uniontown, PA (US); Christoph Wirth, Pfungen (CH); ZhongQiang Tang, Greensburg, PA (US); Jonas Wegmann, Seuzach (CH)

(21) Appl. No.: 19/480,155

(22) PCT Filed: May 4, 2023
(86) PCT No.: PCT/EP2023/061847

§ 371 Date: Oct. 30, 2025

(51) Int. Cl. H01H 33/56

(52) U.S. Cl. CPC H01H 33/562; H01H 2033/568

(57) ABSTRACT

A casing for a circuit breaker includes a main body, an annular tube, and a rupture device. The main body includes an end cover attached to an end of the main body. The annular tube extending from the end cover on an outside of the end cover. The annular tube includes a desiccant holder configured to house a desiccant configured to remove moisture from a gas inside the casing. The rupture device is configured to regulate pressure of the gas housed inside the casing and is detachably mounted to the annular tube at an end thereof remote from the end cover and/or the annular tube is detachably attached to the end cover, and wherein a spacing defined by the desiccant holder is accessible from an end of the annular tube.

### CROSS REFERENCE TO RELATED APPLICATIONS

This application is a 35 U.S.C. § 371 national stage application of PCT International Application No. PCT/EP2023/061847 filed on May 4, 2023, the disclosure and content of which is incorporated by reference herein in its entirety.

### TECHNICAL FIELD

The present disclosure generally relates to a circuit breaker provided with a desiccant holder.

### BACKGROUND

A circuit breaker is used for protection against overload or short circuit in electrical systems. The main principle of the circuit breaker is to abruptly break a circuit and safely quench an arc which is created by an interrupter. The circuit breaker includes a casing which houses the interrupter using support tubes. In addition, the casing of the circuit breaker also includes one or more end covers. The aforementioned circuit breaker includes a high pressure insulating gas which is used as arc extinguishing medium. In some examples, the high pressure insulating gas is SF₆ gas. In addition, the circuit breaker includes a desiccant material which is mounted on an inside of the end cover of the casing. The desiccant material is responsible for adsorbing moisture inside the casing of the circuit breaker.

The above desiccant material may benefit from periodic maintenance and/or replacement. To perform the maintenance and/or replacement of the desiccant material in the aforementioned circuit breaker, numerous components of the circuit breaker are disassembled. In some examples, the end cover, the support tube, and the interrupter are disassembled for maintenance and/or replacement.

However, the disadvantage of this solution is that the aforementioned components of the circuit breaker are heavy and may employ external lifting arrangements to be disassembled and reassembled. This increases the overall time consumed in the maintenance and/or replacement of the desiccant material. In addition, while disassembling and reassembling the components, the desiccant material is likely to have long exposure to environment and hence, causing the desiccant to lose its absorbing properties.

### SUMMARY

Consequently, there is a need for a circuit breaker that includes a desiccant holder which is easily and quickly accessible while performing maintenance and/or replacement of the desiccant material.

It is therefore an object of the present disclosure to provide a circuit breaker and a desiccant holder that is easily and quickly accessible while performing maintenance and/or replacement of the desiccant material.

According to a first aspect of the present disclosure, a circuit breaker is provided. The circuit breaker includes a casing. The casing further comprises a main body, an annular tube, and a rupture device. In addition, an end cover may be attached to an end of the main body. The annular tube may extend from the end cover on an outside of the end cover, in which the annular tube includes a desiccant holder. The desiccant holder is configured to house a desiccant configured to remove moisture from a gas inside the casing when the desiccant is housed in the desiccant holder. The rupture device is configured to regulate pressure of the gas housed inside the casing, in which the rupture device is detachably mounted to the annular tube at an end thereof remote from the end cover and/or the annular tube is detachably attached to the end cover. In an example, a spacing defined by the desiccant holder and configured to house the desiccant is accessible from an end of the annular tube which is detachably attached to one of the end cover and the rupture device.

In some embodiments, the rupture device is detachably mounted to the annular tube, and upon detachment of the rupture device an opening is formed on the annular tube, wherein the desiccant, when mounted in the desiccant holder, is accessible from said opening.

Advantageously, during maintenance, the above configuration of the circuit breaker allows the rupture device and the annular tube to be disassembled and reassembled without disassembling the numerous other components of the circuit breaker. Hence, the maintenance and/or replacement of desiccant can be performed in an easy and quick manner. As a result, the desiccant is less likely to have long exposure to environment and hence, the desiccant material can absorb moisture from the gas efficiently.

In some embodiments, the annular tube is constructed as an integral part of the end cover. In such cases, the annular tube has to be designed such that the desiccant is accessible from an end of the annular tube which is detachably attached to the rupture device, upon removal of the rupture device from the annular tube.

In some embodiments, the circuit breaker includes an interrupter inside the main body and a rear support tube for supporting the interrupter, in which the end cover is connected to the rear support tube.

In some embodiments, the annular tube includes an inner pipe that is configured to be at least partly surrounded by the desiccant, and in which the inner pipe is perforated. In some embodiments, the rupture device is mounted to the annular tube by one or more of: bolting or screwing.

In some embodiments, the rupture device may include a membrane that allows the gas to escape the casing if the pressure inside the casing is greater than a threshold. In an example, the gas inside the casing may be an electrically insulating gas. For example, the insulating gas may be a C4FN gas or a SF₆ gas.

In some embodiments, the gas comes in contact with the desiccant through the perforations of the inner pipe. In an example, upon rupture of the rupture device, the gas moves out of the casing through the inner pipe and the rupture device. Thereby, gas moving out of the circuit breaker upon rupture of the rupture device does not pass right through the desiccant, since the desiccant is located around and outside said inner pipe. Thereby, spreading of the desiccant to the environment during such evacuation is prevented as a result of the claimed design.

In an embodiment, the desiccant is arranged on the desiccant holder. In an example, the desiccant includes a particulate desiccant material and a sack in which the particulate desiccant material is housed.

Other advantages may be readily apparent to one having skill in the art. Certain embodiments may have some, or all of the recited advantages.

### BRIEF DESCRIPTION OF THE DRAWINGS

The foregoing will be apparent from the following more particular description of the example embodiments, as illustrated in the accompanying drawings in which like reference characters refer to the same parts throughout the different views. The drawings are not necessarily to scale, emphasis instead being placed upon illustrating the example embodiments.

FIG. 1 discloses a circuit breaker including a desiccant holder of the prior art;

FIG. 2 discloses a circuit breaker including a desiccant holder according to some embodiments of the present disclosure;

FIG. 3 discloses a sectional view of the circuit breaker according to some embodiments of the present disclosure;

FIG. 4 discloses a sectional view of the annular tube and the rupture device according to some embodiments of the present disclosure;

FIG. 5 discloses a sectional view of the annular tube with the rupture device disassembled according to some embodiments of the present disclosure.

### DETAILED DESCRIPTION

Aspects of the present disclosure will be described more fully hereinafter with reference to the accompanying drawings. The apparatus disclosed herein can, however, be realized in many different forms and should not be construed as being limited to the aspects set forth herein. Like numbers in the drawings refer to like elements throughout.

The terminology used herein is for describing particular aspects of the disclosure only and is not intended to limit the disclosure. It should be emphasized that the term “comprises/comprising” when used in this specification is taken to specify the presence of stated features, integers, steps, or components, but does not preclude the presence or addition of one or more other features, integers, steps, components, or groups thereof. As used herein, the singular forms “a”, “an” and “the” are intended to include the plural forms as well, unless the context clearly indicates otherwise.

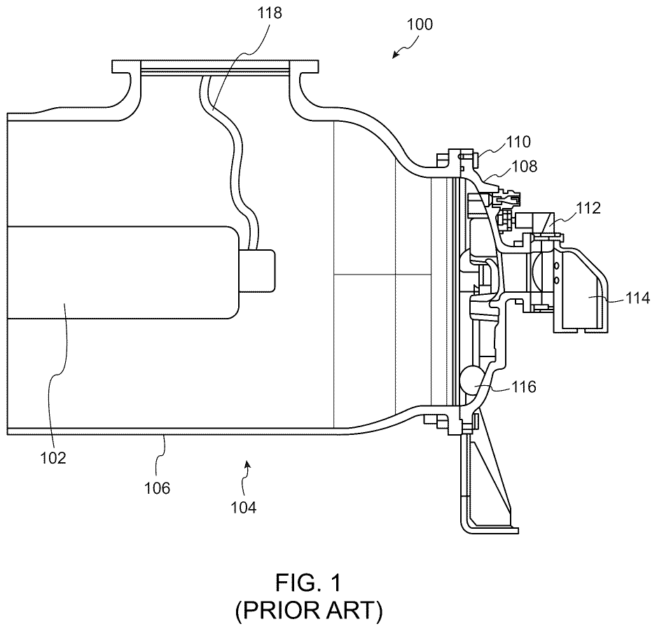

FIG. 1 (Prior Art) discloses a circuit breaker 100 to abruptly break a circuit and safely quench an arc which is created by an interrupter 102. The circuit breaker 100 comprises a casing 104. The casing 104 further includes a main body 106 having an end cover 108. The end cover 108 is fastened to the main body 106 by bolts 110. Further, a rupture device 112 extends from the end cover 108 on an outside of the end cover 108. The rupture device 112 is configured to regulate pressure of an insulating gas housed inside the casing 104. Further, the rupture device is also connected to a duct 114 configured to direct the flow of the insulating gas. In addition, the casing 104 includes a desiccant holder 116 on an inner lining of the end cover 108. The desiccant holder 116 is configured to house a desiccant.

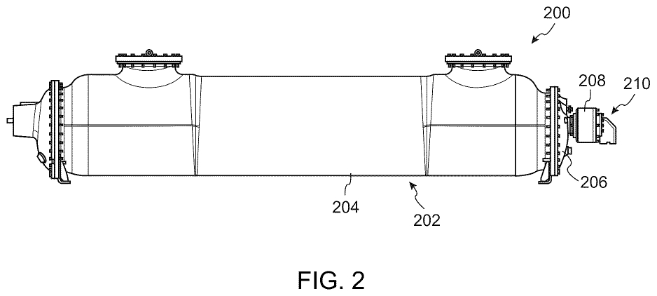

Further, the desiccant mentioned above may benefit from periodic maintenance and/or replacement. To perform the maintenance and/or replacement of the desiccant in the aforementioned circuit breaker 100, numerous components of the circuit breaker 100 are disassembled. Specifically, the interrupter 102, the end cover 108, the rupture device 112, the duct 114, and a guide rod 118 are disassembled for maintenance and/or replacement. The disadvantage of this solution is that the aforementioned components of the circuit breaker 100 are heavy and may employ external lifting arrangements to be disassembled and reassembled. This increases the overall time consumed in the maintenance and/or replacement of the desiccant. In addition, while disassembling and reassembling the components, the desiccant is likely to have long exposure to environment and hence, causing the desiccant to lose its moisture absorbing properties. According to some embodiments of the present subject matter, as depicted in FIG. 2, discloses a circuit breaker 200. The circuit breaker 200 includes a casing 202. The casing 202 further includes a main body 204 having an end cover 206. The end cover 206 is fastened to the main body 204 by bolts (not shown). Further, an annular tube 208 extends from the end cover 206 on an outside of the end cover 206. The main body 204 also includes a rupture device 210 which is detachably mounted to the annular tube 208 at an end thereof remote from the end cover 206. The rupture device 210 is configured to regulate pressure of an insulating gas housed inside the casing 202. The rupture device 210 is designed to rupture as the gas pressure inside the casing exceeds a predetermined threshold value, and thus evacuate gas from the casing 202. In an example, the annular tube 208 is also detachably attached to the end cover 206.

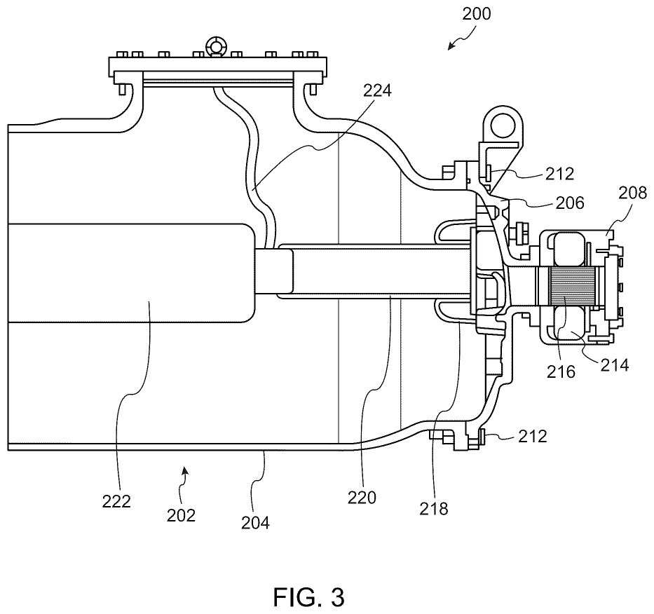

As shown in FIG. 3 that discloses a sectional view of the circuit breaker 200, the end cover 206 of the circuit breaker 200 is fastened to the main body 204 by bolts 212. In an example, the end cover 206 is fastened to the main body 204 by a screwing arrangement (not shown). In one example, the annular tube 208 may be constructed as an integral part of the end cover 206. In another example, the annular tube 208 is also detachably attached to the end cover 206. Further, the annular tube 208 comprises a desiccant holder 214 configured to house a desiccant (not shown). The desiccant is configured to remove moisture from the insulating gas inside the casing 202 by absorption of moisture.

In an embodiment, the annular tube 208 includes an inner pipe 216 which is configured to be at least partly surrounded by the desiccant (not shown). In an example, the inner pipe 216 may be perforated. In addition, the casing 202 includes flanges 218 configured to hold a rear support tube 220. In an example, the rear support tube 220 configured to hold an interrupter 222. The interrupter 222 further includes a guide rod 224 configured to be connected to a bushing (not shown).

The insulating gas may interact with the desiccant (not shown) through one or more holes on the perforated inner pipe 216. In an example, the insulating gas may be a C4FN gas. In another example, the insulating gas may be a SF₆ gas.

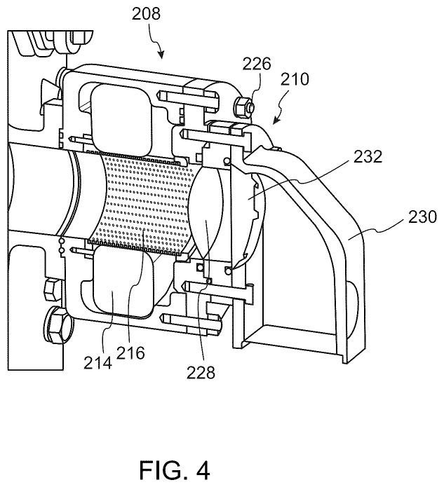

Further, in an example, as shown in FIG. 4 that discloses a sectional view of the annular tube 208 and the rupture device 210, the rupture device 210 may be detachably mounted to the annular tube 208 by bolts 226. In another example, the rupture device 210 may be mounted to the annular tube 208 by screws (not shown).

In an embodiment, the rupture device 210 includes a membrane 228 that allows the insulating gas to escape the casing 202 (of FIG. 3) if the pressure inside the casing 202 (of FIG. 3) is greater than a threshold. In an example, the insulating gas moves out of the casing 202 (of FIG. 3) through the inner pipe 216 and the rupture device 210. Further, the rupture device 210 includes a duct 230 and a thin sheet 232 which are configured to keep dirty atmosphere air away from the membrane 228. In an example, the duct 230 may be bolted or screwed to the rupture device 210.

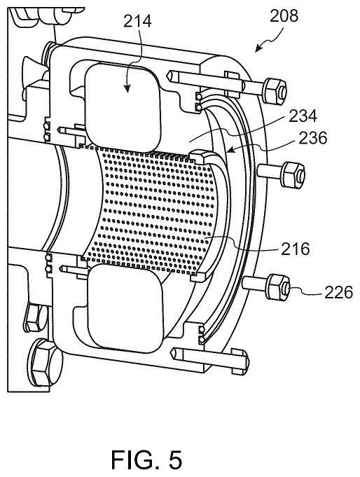

As shown in FIG. 5 that discloses a sectional view of the annular tube 208 with the rupture device 210 disassembled, the desiccant holder 214 houses a desiccant 234. In addition, as mentioned above the perforated inner pipe 216 is configured to be at least partly surrounded by the desiccant 234. In an example, upon detachment of rupture device 210 (of FIG. 4.) an opening 236 is formed on the annular tube 208, and in which the desiccant 234, when mounted in the desiccant holder 214, is accessible from the opening 236.

In an embodiment, the desiccant 234 includes a particulate desiccant material and a sack wherein the particulate desiccant material is housed. In one example, the sack housing the particulate desiccant material may be constructed of a flexible material. Further, the sack may have a torus geometry. In another example, the sack may extend like a torus around the inner pipe 216. Further, in an embodiment, the desiccant 234 may be a type 4A-XH-5 desiccant used in refrigeration system.

Accordingly, during the maintenance and/or replacement of the desiccant 234, the rupture device 210 (of FIG. 4) may be disassembled and thereby forming the opening 236. Further, the desiccant 234 is accessible for maintenance and/or replacement via the opening 236. Therefore, maintenance and/or replacement of the desiccant 234 can be performed in an easy and quick manner without disassembling the numerous heavy components of the circuit breaker 200 (of FIG. 3). As a result, the total time consumed in maintenance of the desiccant is minimized and the desiccant 234 is less likely to have long exposure to environment and hence, the desiccant 234 may absorb moisture from the insulating gas efficiently.

The foregoing description of the specific embodiments will so fully reveal the general nature of the embodiments herein that others can, by applying current knowledge, readily modify and/or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments herein have been described in terms of preferred embodiments, those skilled in the art will recognize that the embodiments herein can be practiced with modification within the scope of the disclosure.

1-12. (canceled)

13. A circuit breaker, comprising a casing, wherein the casing comprises:
a main body and an end cover attached to an end of the main body;
an annular tube extending from the end cover on an outside of the end cover, wherein the annular tube comprises a desiccant holder configured to house a desiccant configured to remove moisture from a gas inside the casing when the desiccant is housed in the desiccant holder;
a rupture device configured to regulate pressure of the gas housed inside the casing, wherein the rupture device is detachably mounted to the annular tube at an end thereof remote from the end cover, and wherein a spacing defined by the desiccant holder and configured to house the desiccant is accessible from an end of the annular tube which is detachably attached to the rupture device;
wherein upon detachment of the rupture device an opening is formed on the annular tube, and wherein the desiccant, when mounted in the desiccant holder, is accessible from said opening.

14. The circuit breaker as claimed in claim 13, wherein the annular tube is constructed as an integral part of the end cover.

15. The circuit breaker as claimed in claim 13, comprising an interrupter inside the main body and a rear support tube for supporting the interrupter, wherein the end cover is connected to the rear support tube.

16. The circuit breaker as claimed in claim 13, wherein the annular tube has an inner pipe that is configured to be at least partly surrounded by the desiccant, and wherein the inner pipe is perforated.

17. The circuit breaker as claimed in claim 13, wherein the rupture device is mounted to the annular tube by one or more of: bolting or screwing.

18. The circuit breaker as claimed in claim 13, wherein the rupture device comprises a membrane that allows the gas to escape the casing if the pressure inside the casing is greater than a threshold.

19. The circuit breaker as claimed in claim 13, wherein the gas inside the casing is an insulating gas.

20. The circuit breaker as claimed in claim 16, wherein the gas comes in contact with the desiccant through the perforations of the inner pipe.

21. The circuit breaker as claimed in claim 16, wherein the gas moves out of the casing through the inner pipe and the rupture device.

22. The circuit breaker as claimed in claim 13, wherein the desiccant is arranged on the desiccant holder.

23. The circuit breaker as claimed in claim 22, wherein the desiccant comprises:
a particulate desiccant material; and
a sack wherein the particulate desiccant material is housed.
